(19) United States
(12) Patent Application Publication
(10) Pub. No.: US 2008/0035322 A1
(43) Pub. Date: Feb. 14, 2008

(54) Motor Vehicle Air Conditioning System

(75) Inventor: Henri Klein, Colmar (FR)

Correspondence Address: FOLEY AND LARDNER LLP;SUITE 500, 3000 K STREET NW, WASHINGTON, DC, 20007, US

(73) Assignee: BEHR FRANCE ROUFFACH SAS

(21) Appl. No.: 11/814,319

(22) PCT Filed: Jan. 12, 2006
(86) PCT No.: PCT/EP06/00200

§ 371 Date: Aug. 20, 2007

(30) Foreign Application Priority Data
Jan. 21, 2005 (EP) 05290143.6

(51) Int. Cl. B60H 1/00

(52) U.S. Cl. 165/203; 454/139

(57) ABSTRACT

The invention relates to a motor vehicle air conditioning unit (1) which is used to temper the front area of a motor vehicle. Said motor vehicle air conditioning unit comprises one first blower (2), an evaporator (4) and a heater (5) and, optionally, an additional heater (6) and an air channel (10) which is used to ventilate the rear. At least one additional, second blower (13) comprising a blower housing (14) is arranged in the air channel (10) which is used to ventilate the rear. Said air channel (10), which is used to ventilate the rear, is a cold air channel.

The invention relates to a motor vehicle air conditioning system according to the preamble of claim 1.

In motor vehicle air conditioning systems having rear ventilation, the supply of the rear region with sufficient air, in particular with air which is temperature-controlled to a certain extent, is problematical as a rule. On account of the channel length, an additional fan which conveys the air to the rear can be provided in the air channel. A design of this type does not permit separate temperature control of the air which is fed to the rear space, with the result that the front and rear regions are supplied approximately with air at the same temperature.

As an alternative, two air conditioning systems can be provided, which is very complicated and expensive, however.

It is an object of the invention to provide an improved but relatively inexpensive motor vehicle air conditioning system.

This object is achieved by a motor vehicle air conditioning system having the features of claim 1. Advantageous refinements are the subject matter of the subclaims.

According to the invention, a motor vehicle air conditioning system is provided which is designed for temperature control of the rear region, having an air channel for the rear ventilation, at least one additional, second fan having a fan housing being arranged in the air channel for the rear ventilation, and the air channel for the rear ventilation being a cold air channel. As a result, sufficient cold air can be transported into the rear region via the air channel, assisted by the conveying action of the second fan, with the result that sufficient cooling is possible.

The fan housing preferably has an additional, controllable recirculated air inlet for sucking in recirculated air from the vehicle interior. As a result, warm recirculated air can be mixed in a simple manner with the cold air which comes from the air conditioning system, with the result that warmer air than in the front region is never fed into the rear region, which is advantageous, in particular, at low outside temperatures.

The cold air inlet of the cold air channel into the fan housing can preferably (also) be controlled, with the result that temperature control of the air which is fed to the rear region is possible overall in a simple and relatively inexpensive manner. Here, the front air conditioning system is not complicated and the temperature control of the front region is not influenced or is only influenced to an insubstantial extent.

A flap, in particular a drum flap or ball flap, is preferably provided for temperature control, which flap opens completely or partially or closes the cold air inlet as a function of the desired temperature in the rear region, and correspondingly closes or opens partially or completely the recirculated air inlet. In this way, very simple and inexpensive control of the temperature of the air which is fed to the rear region is possible. If there are two or more cold air and recirculated air inlet pairs, preferably one flap is provided per inlet pair, the individual flaps being coupled to one another, in particular, with the result that the openings which are opened in each case of the cold air and recirculated air inlets correspond with one another. As a result, simple control can be realized even in the case of a plurality of flaps.

Depending on the installation space which is available, at least one flap can be configured as a simpler single vane or double vane pivoting flap in a further simpler variant.

The cold air channel preferably branches off from the air conditioning system after the evaporator and in front of the heater and optionally supplementary heater. In this region, there is usually sufficient space structurally for a branching of an air channel, with the result that the air guiding housing of the air conditioning system is not complicated substantially.

Two cold air channels are preferably provided which are routed to the second fan. It goes without saying that only one cold air channel or more than two cold air channels can also be provided; however, for structural reasons, two cold air channels which are configured symmetrically with respect to one another are advantageous, in particular for the installation of the second fan between the two front seats.

The two cold air channels are preferably routed to the second fan from sides which lie opposite one another.

Two recirculated air channels are preferably provided which are likewise routed to the second fan; they are also preferably routed to the second fan from sides which lie opposite one another, with the result that overall a symmetrical design preferably results.

In the following text, the invention will be explained in detail using an exemplary embodiment with reference to the drawing, in which:

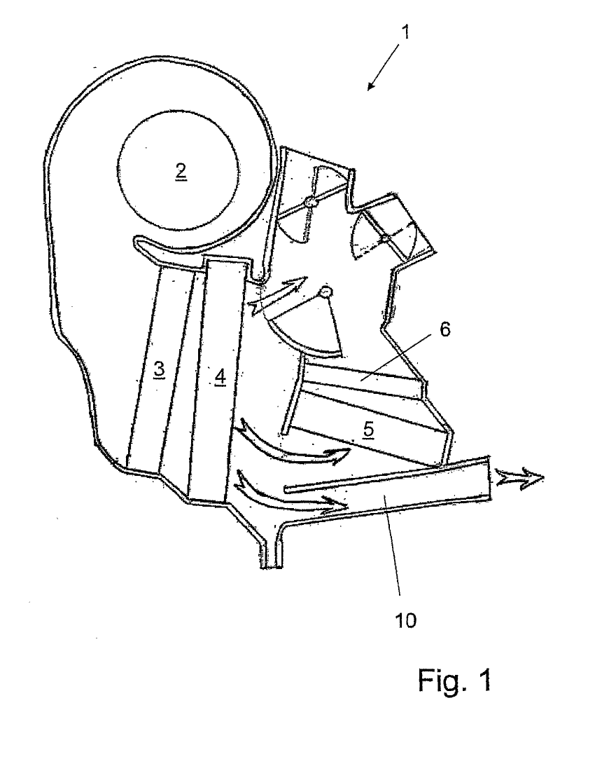

FIG. 1 shows a diagrammatically illustrated section through a motor vehicle air conditioning system having a cold air channel which branches off,

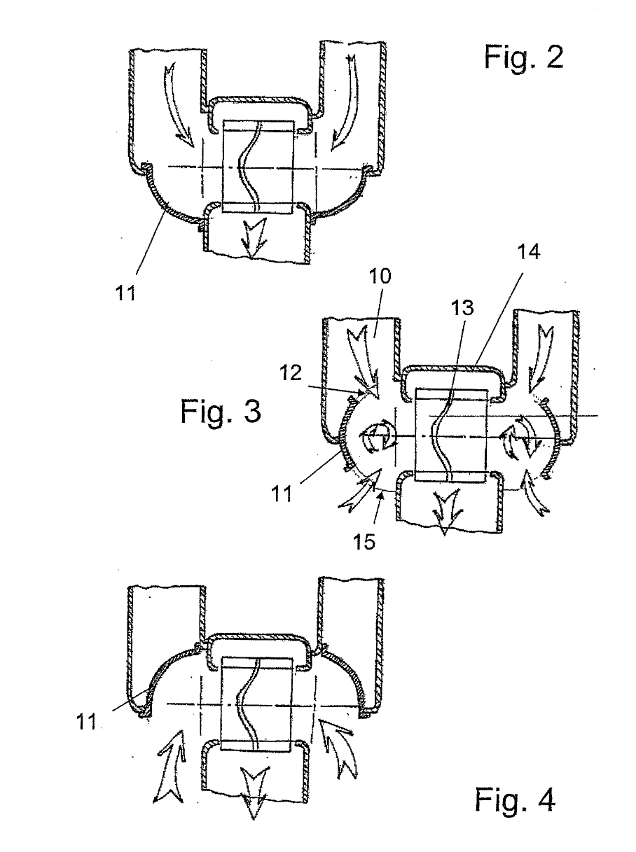

FIG. 2 shows a diagrammatically illustrated section through a fan which is arranged in the cold air channel, in the operating position “100% cold”,

FIG. 3 shows a diagrammatically illustrated section through a fan which is arranged in the cold air channel, in a mixing mode,

FIG. 4 shows a diagrammatically illustrated section through a fan which is arranged in the cold air channel, in the operating position “100% warm”, and

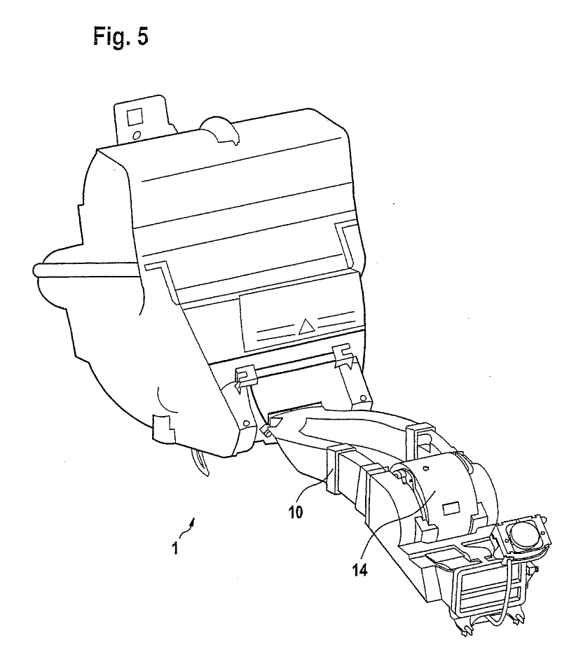

FIG. 5 shows a perspective view of the air conditioning system.

A motor vehicle air conditioning system 1 having a first fan 2, a filter 3, an evaporator 4, a heater 5 and a supplementary heater 6 is designed, in particular, for the ventilation and temperature control of the front region of a motor vehicle interior. For this purpose, the first fan 2 sucks in air from the surroundings and/or the vehicle interior. The air is guided through the filter 3 and the evaporator 4 and optionally also through the heater 5 and supplementary heater 6 and is fed as required, that is to say according to the setting, to the vehicle interior in the front region, that is to say to the footwell and the central and side nozzles or, in the case of defrosting, to the windshield, in particular.

Part of the air which is sucked in by the fan 2 is fed to the rear region (see FIG. 1) via an air channel 10, this being a cold air channel on account of the location of the branching after the evaporator 4 and in front of the heater 5 and the supplementary heater 6. In the present case, two air channels 10 are provided (see, for example, FIG. 5).

The two air channels 10 open into a fan housing 14 of a second fan 13 via in each case one cold air inlet 12 which is controlled by a flap 11, in the present case a drum flap, which fan housing 14 is arranged between the front seats of the motor vehicle in the present case. In one variant, the flaps 11 can also be configured as ball flaps, said flaps 11 having a substantially cylindrical closing face if they are configured as drum flaps and having a substantially spherical closing face if they are configured as ball flaps. It goes without saying that it is also possible for one flap 11 to be configured as a drum flap and for a second flap 11 to be configured as a ball flap. The two flaps 11 are coupled to one another via a kinematic means and can be pivoted. Two further recirculated air inlets 15 for recirculated air which is sucked in by the fan 13 via a recirculated air channel (not shown in greater detail) from the vehicle interior are provided in the fan housing 14 of the second fan 13, which two further circulated air inlets 15 are likewise controlled by the same flaps 11 in the present case. In principle, it would also be possible to provide separately configured flaps for the individual inlets 12 and 15. The air which is sucked in by the fan 13 and is optionally also mixed by the latter is subsequently fed to the rear region of the vehicle interior. The rotational axes of the flaps 11 are arranged perpendicularly with respect to the rotational axis of the fan 13. In an alternative variant which is not shown in the figures, the flaps 11 can also be configured as hemispherical flaps having a rotational axis which is parallel to the rotational axis of the fan 13.

In the flap position which is shown in FIG. 2, the flaps 11 close in each case the recirculated air inlets 15, with the result that only cooled air is conveyed into the rear region by the second fan 13.

FIG. 3 shows a mixing position of the flaps 11. The flaps 11 are pivoted approximately into a central position, as a result of which cooled air can be sucked in by the fan 13 via the channels 10 and recirculated air can be sucked in by the fan 13 via the recirculated air inlets 15 and can be conveyed further in the direction of the rear region.

If it is possible for the cold air which comes from the air conditioning system 1 to be mixed with (warm) circulated air, simple temperature control according to requirements of the air which is fed to the rear region is made possible. If a maximum air throughput is required in the front region, the cold air channel 10 can be closed completely by the flaps 11, as shown in FIG. 4, with the result that the full performance and, in particular, the entire air which is sucked in by the first fan 2 is available for the front region. In this case, however, only the recirculated air is available in the rear region for circulation purposes.

1. A motor vehicle air conditioning system for the temperature control of the front region, having a first fan, an evaporator and a heater, and optionally a supplementary heater and an air channel for the rear ventilation, wherein at least one additional, second fan having a fan housing is arranged in the air channel for the rear ventilation, and in that the air channel for the rear ventilation is a cold air channel.

2. The motor vehicle air conditioning system as claimed in claim 1, wherein the fan housing has an additional, controllable recirculated air inlet for sucking in recirculated air from the vehicle interior.

3. The motor vehicle air conditioning system as claimed in claim 1, wherein the cold air inlet of the cold air channel into the fan housing can be controlled.

4. The motor vehicle air conditioning system as claimed in claim 2, wherein a flap, in particular a drum flap or a ball flap, is provided for temperature control, which flap opens completely or partially or closes the cold air inlet as a function of the desired temperature in the rear region, and correspondingly closes or opens partially or completely the recirculated air inlet.

5. The motor vehicle air conditioning system as claimed in claim 1, wherein the cold air channel branches off from the air conditioning system after the evaporator and in front of the heater and optionally supplementary heater.

6. The motor vehicle air conditioning system as claimed in claim 1, wherein two cold air channels are provided which are routed to the second fan.

7. The motor vehicle air conditioning system as claimed in claim 6, wherein the two cold air channels are routed to the second fan from sides which lie opposite one another.

8. The motor vehicle air conditioning system as claimed in claim 1, wherein two recirculated air channels are vided which are routed to the second fan.

9. The motor vehicle air conditioning system as claimed in claim 8, wherein the two recirculated air channels are routed to the second fan from sides which lie opposite one another.
